(19) United States
(12) Patent Application Publication
(10) Pub. No.: US 2022/0289598 A1
(43) Pub. Date: Sep. 15, 2022

(54) Cathode Coating for an Electrochemical Cell

(71) Applicant: National Oilwell Varco Norway AS, Kristiansand S (NO)

(72) Inventors: Masoud GHORBANIYAN, Stavanger (NO); Øyvind ESPELAND, SANDNES (NO)

(73) Assignee: National Oilwell Varco Norway AS, Kristiansand S (NO)

(21) Appl. No.: 17/633,086

(22) PCT Filed: Aug. 20, 2020
(86) PCT No.: PCT/NO2020/050209

§ 371 Date: Feb. 4, 2022

(30) Foreign Application Priority Data
Aug. 22, 2019 (NO) 20191010

(51) Int. Cl. C02F 1/46; C02F 1/461; C02F 1/467; E21B 43/20

(52) U.S. Cl. CPC C02F 1/4602; C02F 1/46109; C02F 1/4674; E21B 43/20; C02F 2103/08

(57) ABSTRACT

Disclosed is an electrolytic cell having an anode and a cathode, wherein the cathode comprises a surface layer which is repellent towards inorganic material. Such repellent layer may be employed to prevent formation of scale on an electrolytic cell. Also disclosed is an apparatus for cleaning seawater that employs such electrolytic cell, . and a system for injecting cleaned seawater into a hydrocarbon reservoir, wherein the system comprises tubing, an injection pump, and the seawater cleaning apparatus employing the disclosed electrolytic cell.

### CROSS REFERENCE TO RELATED APPLICATIONS

This application is a 35 U.S.C. § 371 national stage application of PCT/N02020/050209 filed Aug. 20, 2020 and entitled “Cathode Coating for an Electrochemical Cell”, which claims priority to Norwegian Patent Application No. 20191010 filed Aug. 22, 2019, each of which is incorporated herein by reference in their entirety for all purposes.

### STATEMENT REGARDING FEDERALLY SPONSORED RESEARCH OR DEVELOPMENT

Not application

### FIELD OF THE DISCLOSURE

This disclosure relates to an electrolytic cell comprising an anode and a cathode, to an apparatus comprising the electrolytic cell, to a system comprising the apparatus, to use of the electrolytic cell, and to a method for making an electrolytic cell less susceptible to build-up of scale.

### BACKGROUND OF THE DISCLOSURE

Electrochemical production of oxidants via electro chlorinators and hydroxyl radical generators are well known and widely used in the water treatment industry, where the purpose is to inactivate organics present in the water and thus provide disinfection.

A saltwater chlorinator for water treatment plants traditionally includes an electrolysis cell comprising parallel plates of anodes and cathodes. The saltwater chlorinator generates chlorine, which functions as a disinfecting agent. The main by-products of any saltwater electrolysis process are generation of hydrogen gas (H₂) and precipitation of insoluble salt.

A hydroxyl radical generator is similar to an electro chlorinator, but it has different materials on the cathode and anode. Oxidants such as hydroxyl radicals are extremely reactive and will be converted to another chemical molecule within nanoseconds. As such highly reactive radicals are generated at the surface of the electrodes in a hydroxyl radical generator, only water which is close to the electrodes will be treated by these radicals.

Water and oxygen reduction reactions near the cathode cause release of oxidants and creation of an alkaline environment, while oxidation reactions at the anode cause an acidic environment. If the water contains inorganic ions such as calcium and magnesium, for example as present in sea water, the alkaline environment will typically induce precipitation of these ions, for example of calcium in the form of CaCO₃ and magnesium in the form of Mg(OH)₂. Such precipitate is generally known as scale.

The rate of deposition and type of material deposited on the cathode will depend on the electrical current and the temperate and chemistry of the water. In the complex case of seawater electrolysis, slightly different materials may be deposited on the cathode due to different growth rates of calcium or magnesium salts. This may result in different physical properties of the deposited material, e.g. different hardness, texture, or colour.

Formation of scale is a considerable challenge in electrolytic device designs where precipitation due to chemical reactions forms a deposit on the cathodes of the device, and thereby creates a significant restriction or even plug. Scale growth will over time significantly reduce the cathode contact area and thereby the disinfection efficiency, and increase the pressure drop across the cell due to reduced flow area.

Different methods to deal with the problem of scale formation in addition to lifting the cell out of the water and clean it mechanically have been proposed. For example, U.S. Pat. No. 3,822,017 A discloses an electrical chlorination unit which has scrapers to mechanically remove the scale, US2015233003 AA discloses a method for decreasing the rate of formation of scale by intermittently injecting jets of pressurized water, and US2006027463 AA discloses an electrolytic cell wherein ozonated air bubbles are used to decrease the formation of scale by attracting particles of scale and transporting them away from the electrode. However, these solutions will make the electrochemical cell more complex, and thereby more expensive and prone to malfunction. U.S. Pat. No. 5,034,110 A discloses a self-cleaning chlorinator comprising a power supply which cyclically reverses the polarity at the electrodes to remove the scale deposits. A disadvantage of reversing the polarity is that the electrodes may be damaged, and their lifetime reduced. This is especially disadvantageous for subsea applications, where the installation may be very expensive if the electrochemical cell is positioned e.g. at the seabed, which may in worst case be several hundred kilometres offshore at a depth of several kilometres.

### SUMMARY OF THE DISCLOSURE

This disclosure is provided in an attempt to remedy or to reduce at least one of the drawbacks of the prior art, or at least provide a useful alternative to prior art. This is achieved through features, which are specified in the description below and in the claims that follow.

In a first aspect, the disclosure relates to an electrolytic cell comprising an anode and a cathode, wherein the cathode comprises a surface layer which is repellent towards inorganic material. Since scale mainly consists of inorganic material, a surface layer which is repellent towards inorganic materials will inhibit, reduce, or postpone formation of scale on the cathode, whereby the disadvantages of scale formation will be avoided or decreased. Additionally, any scale which forms on the cathode will typically be very loosely attached, whereby it falls off as flakes when these flakes reach a certain size, for example due to gravity and/or local flow on the water.

The thickness of the surface layer may be very thin, for example equal to or less than 5 μm, equal to or less than 3 μm, or even equal to or less than 1 μm. The surface layer will thereby not inhibit the function of the cathode or electrolytic cell. The molecular structure of the surface layer may be permanently changed to make it unfavourable for inorganic precipitation to adhere. Such treatment is now possible due to recent developments within the field of nanotechnology.

The electrolytic cell may be an electro chlorinator for generating chlorine, or a hydroxyl radical generator for generating free radicals. The surface layer may be especially advantageous for these types of electrolytic cell, since they are typically used to clean water continuously for long periods of time. Formation of scale is therefore a major problem connected to electro chlorinators and hydroxyl radical generators.

The surface layer may be both hydrophobic and oleophobic, which may decrease the tendency of scale formation. Such a surface may decrease the tendency of any material to adhere to said surface, which may result in fewer nucleation sites for the scale to start to nucleate and precipitate.

The electrolytic cell according to the disclosure may be produced by treating the surfaces of the cathode. The surface to be treated may preferably be dry and free of grease and/or wax. If the surface has scratches, rust, or corrosion, it should be cleaned, polished, or sanded before attempting to apply the coating. The coating may not adhere properly if the surface being applied to is glossy

Coating may be applied by spraying it onto the surface, wiping it onto the surface with a lint-free cloth, or dipping the surface into the coating material depending on specific design considerations. In all cases, a consistent thickness and streak-free layer should be achieved on the surface. The coating typically cures very fast. This fast-curing time should preferably be taken into consideration if trying to coat multiple layers. The coating may become tack-free as quickly as 5 minutes or less depending on environmental conditions.

In one embodiment, the surface layer may comprise parachlorobenzotrifluoride and tert-butyl acetate. Result have shown such a surface to be very efficient at inhibiting scale. The surface layer may be made from parachlorobenzotrifluoride, tert-butyl acetate, a suitable ambient-temperature curable resin, and a suitable flow agent.

In one embodiment, the surface layer may comprise methyl nonafluorobutyl ether and methyl nonafluoroisobutyl ether. Results have shown such a surface to be very efficient at inhibiting scale.

In a second aspect, the disclosure relates to an apparatus for cleaning seawater, wherein the apparatus comprises the electrolytic cell according to the description set out above , and wherein the apparatus is configured to be positioned below the seawater surface and to take in surrounding seawater. As maintenance of such an apparatus is difficult if it is positioned below the surface, inhibition of scale is particularly beneficial for this apparatus. For example, the apparatus may be placed on or close to the seabed, whereby maintenance is extremely difficult.

In a third aspect, the disclosure relates to a system for injecting cleaned seawater into a hydrocarbon reservoir, wherein the system comprises tubing, an injection pump, and the apparatus for cleaning seawater described above. Cleaned water is often injected into hydrocarbon reservoirs to increase the production from said reservoirs, as discussed in for example the patent documents WO2004/090284A1, WO2007/073198A1, WO2007/035106A1, and WO2012026827A1. By using the system for injecting cleaned seawater described above , the apparatus may advantageously be placed deep in the water, for example on the seabed, where it will be able to operate for a long period of time without the need for cleaning of the cathode. This will thereby be a very efficient system for injecting cleaned seawater into the reservoir.

In a fourth aspect, the disclosure relates to use of a surface layer which is repellent towards inorganic material to prevent formation of scale on an electrolytic cell.

In a fifth aspect, the disclosure relates to a method for making an electrolytic cell less susceptible to build-up of scale, the electrochemical cell comprising an anode and a cathode, wherein the method comprises the steps of: applying a surface treatment chemical onto a surface of the cathode, wherein the surface treatment chemical is repellent towards inorganic material, and letting the surface treatment chemical dry before use of the electrochemical cell. The surface treatment chemical may for example be applied by brush, or by emerging the cathode into a bath of the liquid surface treatment chemical.

### DETAILED DESCRIPTION OF THE DISCLOSED EXEMPLARY EMBODIMENTS

In the description that follows, examples of preferred embodiments are described.

### EXAMPLE 1

Treatment of the cathode of an electrochemical cell by the surface treatment chemical E9 Metal Ultimate from the E9 treatment series. A titanium cathode was emerged into a liquid bath containing the step 1 composition, i.e. E9 Metal Advantage, of the E9 Metal Ultimate treatment for 30 seconds, followed by drying in room temperature for 24 hours and heat curing at 80° C. for 1 hour. The E9 Metal Advantage comprises less than 2 wt % hydrochloric acid and less than 90% ethyl alcohol. The titanium cathode was then emerged for 2 minutes, 1 minute on each side, into a liquid bath containing the step 2 composition, i.e. the E9 Pro Premium, of the E9 Metal Ultimate treatment, which comprises less than 5 wt % of a fluoro compound, 20-95 wt % ethyl nonafluorobutyl ether, 20-95 wt % ethyl nonafluoroisobutyl ether, 20-95 wt % methyl nonafluorobutyl ether, and 20-95 wt % methyl nonafluoroisobutyl ether, followed by drying for 5 minutes at room temperature. The cathode was then inserted into the electrochemical cell for testing. The subsequent tests revealed that growth of scale was significantly decreased on the treated cathode of the electrochemical cell than on an untreated control cathode.

### EXAMPLE 2

Treatment of the cathode of an electrochemical cell by the surface treatment chemical HD-1 from Surfactis. A titanium cathode was emerged into a liquid bath containing the HD-1 composition for 30 seconds, followed by drying in room temperature for 1 hour. The HD-1 composition comprises less than 5 wt % perfluoropolyether, 20-80 wt % methyl nonafluorobutyl ether, and 20-80 wt % methyl nonafluoroisobutyl ether, followed by drying for 1 hour at room temperature. The cathode was then inserted into the electrochemical cell for testing. The subsequent tests revealed that growth of scale was significantly decreased on the treated cathode of the electrochemical cell than on an untreated control cathode.

### EXAMPLE 3

Treatment of the cathode of an electrochemical cell by the surface treatment chemical NS 200 from Nanoslic. A titanium cathode was emerged into a liquid bath containing the NS 200 composition for 30 seconds, followed by drying in room temperature for 1 hour. The NS 200 composition comprises 20-40 wt % parachlorobenzotrifluoride, 20-40 wt % tert-butyl acetate, 20-40 wt % ambient-temperature curable resin, and 3-6 wt % flow agent. The cathode was then inserted into the electrochemical cell for testing. The subsequent tests revealed that growth of scale was significantly decreased on the treated cathode of the electrochemical cell than on an untreated control cathode.

It should be noted that the above-mentioned exemplary embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb“comprise” and its conjugations does not exclude the presence of elements or steps other than those stated in a claim. The article“a” or“an” preceding an element does not exclude the presence of a plurality of such elements.

1. An electrolytic cell comprising an anode and a cathode, characterised in that the cathode comprises a surface layer which is repellent towards inorganic material.

2. The electrolytic cell according to claim 1, wherein the thickness of the surface layer is equal to or less than 5 μm.

3. The electrolytic cell according to claim 1, wherein the electrolytic cell is an electro chlorinator for generating chlorine, or a hydroxyl radical generator for generating free radicals.

4. The electrolytic cell according to claim 1, wherein the surface layer is both hydrophobic and oleophobic.

5. The electrolytic cell according to claim 1, wherein the surface layer comprises parachlorobenzotrifluoride and tert-butyl acetate.

6. The electrolytic cell according to claim 1, wherein the surface layer comprises methyl nonafluorobutyl ether and methyl nonafluoroisobutyl ether.

7. An apparatus for cleaning seawater, wherein the apparatus comprises the electrolytic cell according to claim 1, and wherein the apparatus is configured to be positioned below the seawater surface and to take in surrounding seawater.

8. A system for injecting cleaned seawater into a hydrocarbon reservoir, wherein the system comprises tubing, an injection pump, and the apparatus according to claim 7.

9. A method of preventing formation of scale on an electrolytic cell comprising using a surface layer which is repellent towards inorganic material.

10. A method for making an electrolytic cell less susceptible to build-up of scale, the electrochemical cell comprising an anode and a cathode, wherein the method comprises the steps of:
applying a surface treatment chemical onto a surface of the cathode, wherein the surface treatment chemical is repellent towards inorganic material, and
allowing the surface treatment chemical to dry before use of the electrochemical cell.

11. The electrolytic cell according to claim 2, wherein the electrolytic cell is an electro chlorinator for generating chlorine, or a hydroxyl radical generator for generating free radicals.

12. The electrolytic cell according to claim 2, wherein the surface layer is both hydrophobic and oleophobic.

13. The electrolytic cell according to claim 3, wherein the surface layer is both hydrophobic and oleophobic.

14. The electrolytic cell according to claim 2, wherein the surface layer comprises parachlorobenzotrifluoride and tert-butyl acetate.

15. The electrolytic cell according to claim 3, wherein the surface layer comprises parachlorobenzotrifluoride and tert-butyl acetate.

16. The electrolytic cell according to claim 4, wherein the surface layer comprises parachlorobenzotrifluoride and tert-butyl acetate.

17. The electrolytic cell according to claim 2, wherein the surface layer comprises methyl nonafluorobutyl ether and methyl nonafluoroisobutyl ether.

18. The electrolytic cell according to claim 3, wherein the surface layer comprises methyl nonafluorobutyl ether and methyl nonafluoroisobutyl ether.

19. The electrolytic cell according to claim 4, wherein the surface layer comprises methyl nonafluorobutyl ether and methyl nonafluoroisobutyl ether.

20. The electrolytic cell according to claim 5, wherein the surface layer comprises methyl nonafluorobutyl ether and methyl nonafluoroisobutyl ether.
